(19) United States
(12) Patent Application Publication
(10) Pub. No.: US 2002/0188630 A1
(43) Pub. Date: Dec. 12, 2002

(54) Method and apparatus for annotating a sequence of frames

(75) Inventor: Kenneth L. Davis, San Diego, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 09/862,884

(22) Filed: May 21, 2001

(51) Int. Cl. G06F 15/00

(52) U.S. Cl. 707/512; 707/502

(57) ABSTRACT

One or more embodiments of the invention provide a method, apparatus, and article of manufacture for annotating a sequence of images. A frame comprises one or more images. A sequence of such frames to be consecutively displayed on a display device is obtained. Annotation information that includes an identification of a frame, an annotation, and a location on the identified frame to display the annotation is obtained. One or more of the sequence of frames are displayed until the identified frame is displayed. When the identified frame is displayed, the display sequence is paused and the annotation is displayed at the specified location.

### BACKGROUND OF THE INVENTION

1. Field of the Invention.

The present invention relates generally to interacting with video, animation, or a sequence of frames on a computer, and in particular, to a method, apparatus, and article of manufacture for annotating video, animation, or a sequence of frames on a computer.

2. Description of the Related Art.

Computer users, developers, and programmers may commonly attach annotations to static images of designs, word processing documents, etc. Annotations may include redlines, text, images, markup data, notes, a box, a circle, an ellipse, a spline, a polyline, a group, an arc, a cloud, a callout, a video (e.g., a video clip), an audio recording (e.g., an audio clip), or any other object/entity that may be used to comment or markup. However, such functionality is not available with respect to video, animation, or a sequence of images displayed on a computer system.

While video clips and animation may be displayed using a computer, the prior art fails to provide a mechanism for a user to markup or comment on the video clip, and/or a sequence of images. Further, the prior art fails to provide a satisfactory method for creating, transmitting, and using such annotations.

### SUMMARY OF THE INVENTION

One or more embodiments of the invention provide the ability to annotate video, animation, or a sequence of frames using a computer. Using embodiments of the invention, users may be provided with the ability to create, transmit, and use such an annotation. One or more advantages that may be available pursuant to the invention include the ability to annotate or provide instructions for the assembly of a product, point out a notable moment in a movie to a friend, comment and illustrate on how a product is operating, or comment and illustrate how a service is being performed.

Annotation information is obtained from a user or application that specifies an annotation, the frame to be annotated, and the location on the frame where the annotation is to be displayed. A sequence of frames such as a video clip or animation is then displayed. When the indicated frame is displayed, the display process is paused and the annotation is displayed/overlaid on the frame at the location specified.

The annotation information may be defined in accordance with an extensible markup language (XML) schema and is likely stored as a separate document/object from the sequence of frames that are being annotated. Since the annotation information is stored separately, it is likely a small document that may be easily and quickly transmitted across a network.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 is a flow chart illustrating the display of an annotation in accordance with one or more embodiments of the invention; and

FIGS. 3A-3E are frames of an animation sequence that illustrates the assembly of a connecting rod in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

Annotation information is obtained that specifies an annotation (or type of annotation), a frame to display the annotation on, and a location that specifies where on the frame the annotation is to be displayed. When a sequence of frames is displayed, the display sequence is paused on the specified frame and the annotation is displayed/overlaid on the frame at the specified location.

Hardware Environment

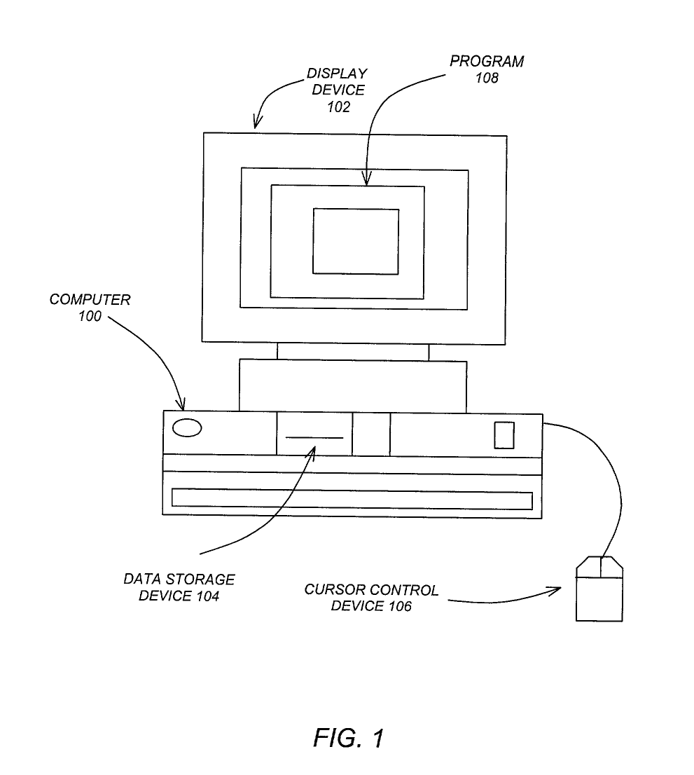

FIG. 1 is an exemplary hardware and software environment used to implement one or more embodiments of the invention. Embodiments of the invention are typically implemented using a computer 100, which generally includes, inter alia, a display device 102 (such as a monitor), data storage devices 104, cursor control devices 106, and other devices. Those skilled in the art will recognize that any combination of the above components, or any number of different components, peripherals, and other devices, may be used with the computer 100. Further, embodiments of the invention may be implemented on a handheld device such as a PalmPilot or Windows CE device that has a display device 102.

One or more embodiments of the invention are implemented by a frame annotation program 108, wherein the frame annotation program 108 is represented by a window displayed on the display device 102. Generally, the frame annotation program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc.

Those skilled in the art will recognize that the exemplary environment illustrated in FIG. 1 is not intended to limit the present invention. Indeed, those skilled in the art will recognize that other alternative environments may be used without departing from the scope of the present invention.

Software Embodiments

In accordance with one or more embodiments of the invention, frame annotation program 108 provides the ability to display a sequence of images, a video, or animation on display device 102. Such a sequence of images may be in a variety of formats including Autodesk Animation, AVI (audio video interleaved), MPEG (moving picture expert group), QuickTime, RIFF (resource interchange file format), animated GIFs (graphic interchange format), ASF (active/advanced streaming format), smacker, Real Media streaming format, Vivo's H.263, Iterated Systems/Progressive Networks/RealNetworks RealVideo/ClearVideo, VDOWave, VxTreme, Duck TrueMotion, or a sequence of still images in separate files. However, embodiments of the invention may be utilized with any type of available format.

The frame annotation program 108 maintains the ability to pause the sequence of images on a particular frame/image and display/overlay an annotation on the frame. Alternatively, instead of displaying/overlaying an annotation on the frame, frame annotation program 108 may play an audio clip, separate video clip, or other multimedia on display device 102.

The annotation may be displayed on a specified location on the paused frame. To provide such capabilities, annotation information is provided to application 108. The annotation information may include the identification of the frame, an annotation, and a location on the identified frame to display the annotation. As described above, an annotation may include redlines, text, images, markup data, notes, a box, a circle, an ellipse, a spline, a polyline, a group, an arc, a cloud, a callout, a video (e.g., a video clip), an audio recording (e.g., an audio clip), or any other object/entity that may be used to comment or markup. Thus, the annotation may be a primitive shape or a complex shape.

The annotation and location may be integrated such that the location specifies a series of points or lines that comprise a line, an arrow, or other object. Alternatively, instead of specifying a location, a default location may be assumed or used. For example, if the annotation comprises text, the application 108 may display the text at a default location such as across the top of the frame.

Additionally, the annotation information may be stored in a file separate from the sequence of images (e.g., the AVI file) that it is associated with. By storing the file separately, the annotation information may be quickly transmitted, transferred, etc.

The annotation information may be defined in accordance with an extensible markup language (XML) schema. Using XML allows the markup/annotation data to be transmitted over standard Internet connections. In the XML data, a tag reference to the sequence of frames associated with the annotation and a frame location for where the markup annotation should appear are provided. The following is an example of the implementation/use of an annotation implemented using an XML document.

```
<Request action = “SavePageXML” PageId = “15”>
  <MarkUp>
    <Objects>
      <Arrow>
        <Line Weight = “1” Style = “0” Color = “255”/>
        <Point2d × = “333.” y = “194.”/>
        <Point2d × = “401.” y = “278.”/>
        <Point2d × = “401.” y = “278.”/>
        <Point2d × = “389.” y = “268.”/>
        <Point2d × = “393.” y = “264.”/>
      </Arrow>
    </Objects>
  </MarkUp>
  <Comments/>
  <Viewers>
    <Viewer type = “Windows Media” ref = “Forensic/animation1.avi”
      sframe = “54”/>
  </Viewers>
</Request>
```

The example above is from a frame annotation program 108 where a user has placed an image of an arrow (see </Arrow>element) (e.g., using a cursor control device 106) that corresponds to frame 54 of an AVI file (<Viewer type=“Windows Media” ref=“Forensic/animation1.avi” sframe=“54”/>). The line weight (<Line Weight=“1” Style=“0” Color=“255”/>) and points (<Point2d x=“” y=“”/>) that are part of the arrow element specify/define the points of the arrow. After loading the above XML document, the frame annotation program 108 will pause the display of the AVI file called “Forensic/animation1.avi” at frame 54 and display the arrow defined by the points specified.

If an annotation other than an arrow were to be utilized, a tag for the element would be provided along with information as to the location of the annotation within the element. For example, a circle annotation may appear as follows:

```
<Circle>
  <Line Weight = “1” Style = “0” Color = “255”/>
  <Point2d × “333.” y = “194.”/>
  <Radius = “5”/>
</Circle>
```

Thus, depending on the type of annotation, different elements may be specified/utilized (e.g., a radius for a circle, text, an equation for a parabola, etc.). Additionally, in the above example, if multiple annotations are used, each annotation may be listed as a new element/object within the <Objects>and </Objects>tags. Annotations may be created/defined by a user (e.g., a person interactng/viewing the sequence of frames) or may be created/defined by any other party (e.g., the creator of the frame sequence).

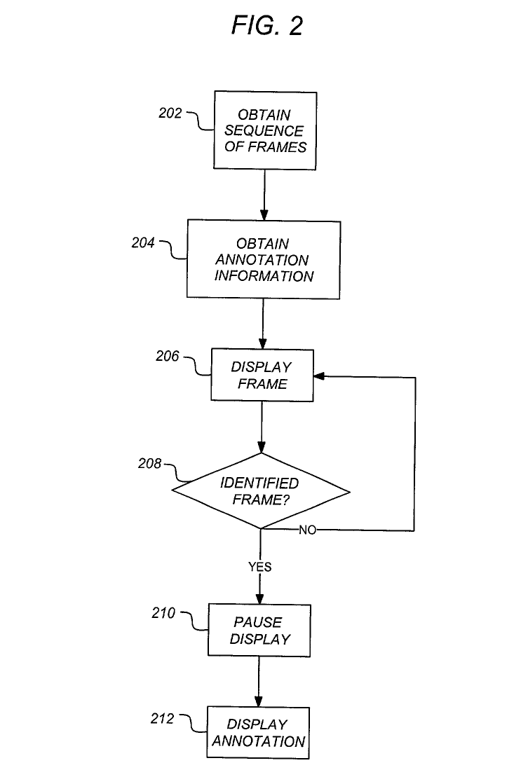

FIG. 2 is a flow chart illustrating the display of an annotation in accordance with one or more embodiments of the invention. At step 202, a sequence of frames is obtained. At step 204, annotation information is obtained. As indicated above, annotation information may include an identification of a frame, an annotation, and a location on the identified frame to display the annotation. At step 206, a frame from the sequence of frames is displayed.

At step 208, a determination is made regarding whether the frame is the identified frame. If not, the process continues and the next frame is displayed at step 206. If the frame is the identified frame, frame annotation program 108 pauses in displaying the sequence of frames at step 210. At step 212, the annotation is displayed/played at the location specified. Thereafter, the sequence of frames may continue to be displayed upon the user electing to proceed (e.g., by selecting a “Play” button or other key on a keyboard or input device that acts to un-pause the frame sequencing).

Specific Examples

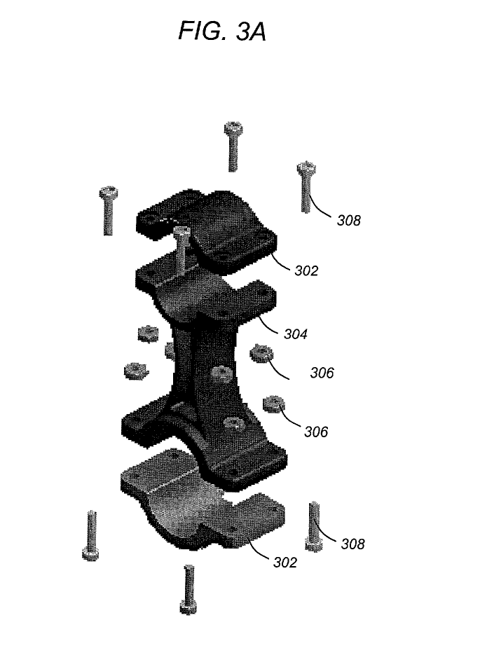

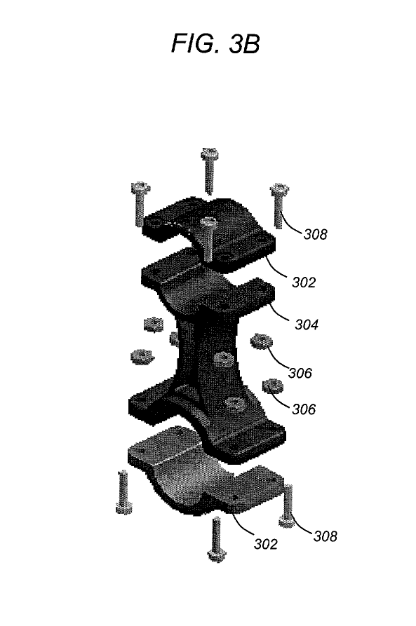

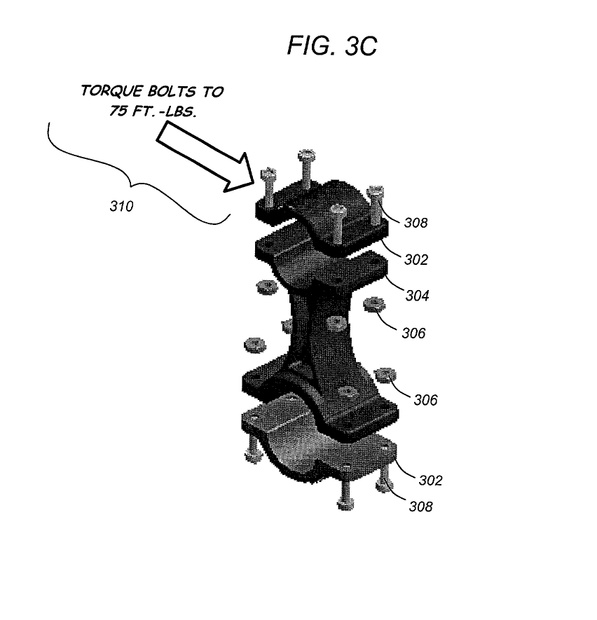

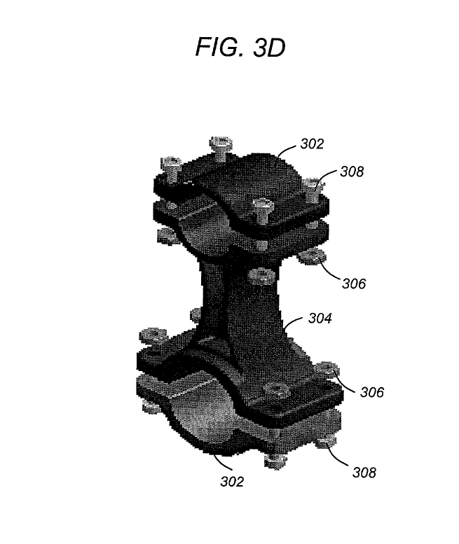

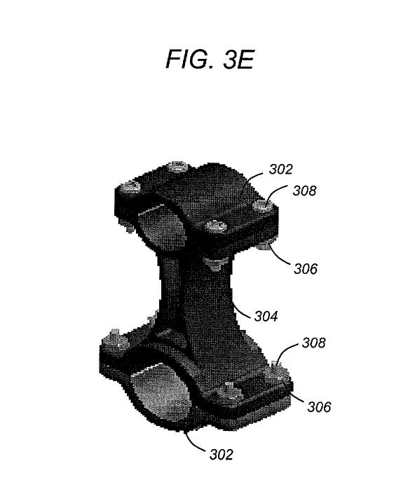

The above described embodiments may be utilized in a variety of situations. For example, FIGS. 3A-3E illustrate frames in an animation sequence for the assembly of a connecting rod. In the animation sequence, the end caps 302 move towards connecting rod 304 and are secured to connecting rod 304 using nuts 306 and bolts 308. FIGS. 3A-3E are each single frames in the sequence. FIG. 3C illustrates an annotation 310 of a frame in the sequence. Thus, during the animation sequence, the animation is paused on the frame of FIG. 3C and annotation 310 appears. In FIG. 3C, annotation 310 is a note with an arrow to a bolt 308 that reminds the user to torque the bolts 308 to a specified level (e.g., 75 ft.-lbs.). The user may then elect to continue the animation (e.g., by pressing a “Play” button), the annotation disappears, and the animation continues with FIGS. 3D and 3E.

In another example, a consumer may purchase a bookshelf from a store and the consumer has to assemble the bookshelf at home. Before leaving the store, the consumer may download the assembly instructions onto the computer 100. The instructions guide the user through the assembly with an animated example. At crucial points in the process, the animation may stop and display additional annotations to further explain the process. The consumer may also add their own notes and annotations to the instructions to be used the next time the item is assembled or disassembled.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, standalone personal computer, Windows CE device, PalmPilot, or handheld computers, could be used with the present invention. In summary, embodiments of the invention provide a method for annotating a sequence of frames. A frame in a sequence, an annotation, and a location on the frame for the annotation is identified and loaded into a frame annotation program 108. The sequence of frames is then displayed. When the identified frame is displayed, the display sequence is paused and the annotation is displayed at the identified location.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A computer-implemented method for annotating, comprising:
(a) obtaining a sequence of frames to be consecutively displayed on a display device, wherein a frame comprises one or more images;
(b) obtaining annotation information, wherein the annotation information comprises:
(i) an identification of a frame;
(ii) an annotation, and
(iii) a location on the identified frame to display the annotation;
(c) consecutively displaying one or more of the sequence of frames until the identified frame is displayed;
(d) pausing the display of the sequence of frames when the identified frame is displayed; and
(e) displaying the annotation at the location.

2. The method of claim 1 wherein the annotation comprises text.

3. The method of claim 1 wherein the annotation comprises an arrow.

4. The method of claim 1 wherein the annotation comprises a primitive shape.

5. The method of claim 1 wherein the sequence of frames comprises an animation.

6. The method of claim 1 wherein the sequence of frames comprises a video.

7. The method of claim 1 wherein the annotation information is defined in conformance with an extensible markup language (XML) schema.

8. The method of claim 1 wherein the displaying of the annotation comprises overlaying the annotation on the paused frame at the location.

9. An apparatus for annotating in a computer system comprising:
(a) a computer system having a memory and a display device coupled thereto;
(b) a sequence of frames stored in the memory, wherein a frame comprises one or more images, and wherein the frames are capable of being consecutively displayed on the display device;
(c) annotation information stored in the memory, wherein the annotation information comprises:
(i) an identification of a frame;
(ii) an annotation; and
(iii) a location on the identified frame to display the annotation;
(d) a computer program executing on the computer system, wherein the computer program is configured to:
(i) display one or more of the sequence of frames until the identified frame is displayed;
(ii) pause the display of the sequence of frames when the identified frame is displayed; and
(iii) display the annotation at the location.

10. The apparatus of claim 9 wherein the annotation comprises text.

11. The apparatus of claim 9 wherein the annotation comprises an arrow.

12. The apparatus of claim 9 wherein the annotation comprises a primitive shape.

13. The apparatus of claim 9 wherein the sequence of frames comprises an animation.

14. The apparatus of claim 9 wherein the sequence of frames comprises a video.

15. The apparatus of claim 9 wherein the annotation information is defined in conformance with an extensible markup language (XML) schema.

16. The apparatus of claim 9 wherein the computer program is configured to display the annotation by overlaying the annotation on the paused frame at the location.

17. An article of manufacture comprising a program storage medium readable by a computer and embodying one or more instructions executable by the computer to perform a method for annotating in a computer system, the method comprising:
(a) obtaining a sequence of frames to be consecutively displayed on a display device, wherein a frame comprises one or more images;
(b) obtaining annotation information, wherein the annotation information comprises:
(i) an identification of a frame;
(ii) an annotation; and
(iii) a location on the identified frame to display the annotation;
(c) consecutively displaying one or more of the sequence of frames until the identified frame is displayed;
(d) pausing the display of the sequence of frames when the identified frame is displayed; and
(e) displaying the annotation at the location.

18. The article of manufacture of claim 17 wherein the annotation comprises text.

19. The article of manufacture of claim 17 wherein the annotation comprises an arrow.

20. The article of manufacture of claim 17 wherein the annotation comprises a primitive shape.

21. The article of manufacture of claim 17 wherein the sequence of frames comprises an animation.

22. The article of manufacture of claim 17 wherein the sequence of frames comprises a video.

23. The article of manufacture of claim 17 wherein the annotation information is defined in conformance with an extensible markup language (XML) schema.

24. The article of manufacture of claim 17 wherein the displaying of the annotation comprises overlaying the annotation on the paused frame at the location.
